(19) United States
(12) Patent Application Publication
(10) Pub. No.: US 2021/0346967 A1
(43) Pub. Date: Nov. 11, 2021

(54) METHOD FOR PRODUCING A FIBER-PLASTICS-COMPOSITE TOOL COMPONENT AND FIBER-PLASTICS-COMPOSITE TOOL COMPONENT

(71) Applicant: Guehring KG, Albstadt (DE)

(72) Inventor: Thomas BISCHOFF, Immenstaad (DE)

(73) Assignee: Guehring KG, Albstadt (DE)

(21) Appl. No.: 17/369,092

(22) Filed: Jul. 7, 2021

Related U.S. Application Data
(63) Continuation of application No. PCT/EP2020/050336, filed on Jan. 8, 2020.

(30) Foreign Application Priority Data
Jan. 8, 2019 (DE) 10 2019 100 297.4

(51) Int. Cl. B23C 5/02; B29C 70/12; B29C 70/50

(52) U.S. Cl. CPC B23C 5/02; B29K 2279/00; B29C 70/504; B29C 70/12

(57) ABSTRACT

The present invention relates to a method for producing a fiber-plastics-composite tool component (1) having a matrix system (6) that has embedded fibers, PBO fibers (4) being selected as the fiber component and a thermosetting plastics matrix (8) being used as the matrix component of the matrix system (6) (S1), which thermosetting plastics matrix has such adhesion to the PBO fibers (4) in the hardened fiber-plastics composite (2) that the coefficient of thermal expansion of the PBO fibers (4) is imparted to the matrix system (6). The invention also relates to a load-bearing tool component (1) of a chip-removing tool in the design of a fiber-plastics-composite press-molded part, the load-bearing tool component (1) comprising a matrix system (6) that has a thermosetting matrix component (8) and comprising PBO fibers (4) embedded into said thermosetting matrix component.

### TECHNICAL FIELD

The present invention relates to a method for producing a fiber-plastics-composite tool component comprising a matrix system comprising embedded fibers. In addition, the invention relates to a (load-bearing) tool component of a chip-removing tool in the design of a fiber-plastics-composite press-molded part.

New materials are used on a regular basis in the field of mechanical engineering. This also applies to fiber-plastics composites (FRP). The fiber-plastics composite is based on the operating principle of composite construction. Various materials are thereby combined in such a way that properties result, which the individual components alone cannot attain. This leads to a synergy effect of fiber and matrix system. High-strength fibers thereby absorbs mechanical loads, which act on the fiber-plastics composite, while the matrix system fixes and supports the fibers in the predetermined position.

The term matrix system/matrix is generally understood to be a ballast compound, which surrounds the fibers. The matrix system in particular adheres the fibers to one another and also transfers forces from one fiber to the next. In response to stress transversely to the fiber direction and shearing stress, the matrix system absorbs the mechanical loads. In response to compressive stress in the fiber longitudinal direction, the matrix has to also support the fibers against shear buckling, and also protects the fibers against environmental influences, chemical reagents, as well as against high-energy radiation.

In turn, the fiber is to have a lowest possible density and additionally, with respect to a size effect, a smallest possible diameter, so that the likelihood of strength-reducing imperfections decreases with an increasing number of fibers. In practice, glass fibers, polyethylene fibers, or aramid fibers, are typically used nowadays.

Due to the above-described interaction, the selection of the combination of the embedded fibers as well as of the matching matrix system selected for a certain field of use plays a significant role. In addition to a good bond between the selected matrix system and the selected fibers, the fiber-plastics composite has to meet further requirements in order to be suitable for a use in a chip-removing tool. The fiber-plastics composite, which is used as material of a load-bearing tool component, e.g. of a tool base body or of an element of a tool base body, such as, for instance, a carrier plate, a clamping portion, or a support portion, has to be adapted in particular to high torsional moments and vibration loads as well as to quickly changing thermal loads or boundary conditions, respectively, and has to satisfy not only one, but all of these requirements equally.

In particular during a use of the load-bearing tool component in a rotary tool for machining large inner diameters, the problem is to perform machining with high precision, without thereby negatively influencing the dimensional stability of the tool due to thermal changes. It must also be taken into account that the weight of the tool or of the load-bearing tool component, respectively, does not have a negative impact on the handling and dimensional stability of the tool, and that a production can nonetheless still be realized economically with available materials.

Attempts to produce load-bearing tool components with fiber-plastics composite as material or with (high-performance) fibers embedded in the matrix system, respectively, remained unsuccessful so far.

### PRIOR ART

DE 10 2017 118 176 A1 discloses a method as well as a molding apparatus for molding a molded part or a vehicle part, respectively. A molding apparatus is provided thereby, which has a first and second compression molding apparatus member, which, together form a closed mold cavity, in order to harden an inserted preform by means of pressurization and heating. An ultrasonic transmitter is used for the energy input. The produced vehicle part, however, has other requirements than a load-bearing tool component for a chip-removing rotary tool. The preform material used for a vehicle part, however, is suitable for the use in a load-bearing tool component of a rotary tool with corresponding requirements for a mechanical strength, resistance, long service life, and dimensional stability. In the field of the tool production, it is already known from DE 10 2010 036 874 A1, however, to use FRP components as cutter holder or as cutter insert.

### SUMMARY OF THE INVENTION

It is thus the object of the invention to provide a method for producing a fiber-plastics-composite tool component, by means of which it is possible to produce load-bearing tool components with significantly enlarged construction volume in a simple and efficient manner. A further object is to provide such a load-bearing tool component, which is no longer limited with respect to the construction volume, as well as to make such a (load-bearing) tool component available.

With respect to the method, the object is solved by means of the method steps of claim 1, and with respect to the tool component by means of the features of claim 14, which allows for a simple and efficient production of the tool component, and which permits an efficient use of the tool component in a tool, is characterized by a high durability and long service life, as well as by a very good handling, can be produced cost-efficiently, and nonetheless satisfies the requirements of a high mechanical strength and of a high dimensional stability.

PBO fibers is selected as fiber component of the fiber-plastics composite, and a thermosetting plastic matrix is used or selected, respectively, as matrix component of the matrix system, which has such a bond to the PBO fiber in the hardened fiber-plastics composite that the coefficient of thermal expansion and/or the tensile strength of the PBO fibers is imparted to the matrix system. The method is therefore characterized in that a fiber-matrix combination is used, which is optimally adapted to the field of use of the tool component.

Compared to aramid fibers, PBO fibers are characterized by a significantly higher stiffness of the fiber, a significantly smaller moisture absorption, and a significantly improved stability against UV light. Compared to other polymer high-performance fibers, which is known, e.g., under the brand name “Dyneema”, the PBO fiber moreover has a very good fiber-matrix bond, in particular compared to a thermosetting plastic matrix.

By means of the step of the defined selection of the PBO fibers as well as by means of the step of the defined selection of the thermosetting plastic matrix as matrix component of the matrix system, which has a sufficient bond to the PBO fibers such that the PBO fibers are held firmly with the matrix system, it is attained that significant properties of the PBO fibers, in particular the coefficient of thermal expansion of the PBO fibers, can be transferred to the fiber-plastics composite, and the “overall” property of the fiber-plastics composite is thus decisively determined by the PBO fiber. It can thus in particular be attained that by means of the step of the selection of the specific components, an extremely good dimensional stability can be ensured during thermal stress, even in the case of large construction volumes. The specifically selected fiber-plastics composite thus satisfies the most important requirements of the field of use of a tool component, even if the latter has very large dimensions.

Thermosetting plastics as component of the matrix system have macromolecules consisting of multi-functional monomers, wherein the hard molding compound is created by means of chemical crosslinking reaction (hardening). Due to the narrow and spatial net structure, they have a high modulus of elasticity, a low creep tendency, as well as a very good thermal and chemical strength, which is why they are only weakly swellable and insoluble. The processing thereof is also relatively unproblematic. They are thus optimally suitable as matrix component for a use in a chip-removing tool.

In their properties, the PBO fibers (poly(p-phenylene-2,6-benzobisoxazole) or poly[Benz(1,2-D:5,4-D′)bisoxazole-2,6-diyl-1,4-phenylene] fibers, respectively, or poly-p-phenylene-benzobisoxazole fibers, respectively, also known under the brand name Zylon®, in contrast, are partially similar to the aramid fibers, but have a very strong negative coefficient of thermal expansion α of below −6E-6 1/K. By means of embedding the PBO fibers into the thermosetting matrix system, a fiber-plastics composite with a particularly low coefficient of thermal expansion is established, in order to be used as material of a tool component, in particular of a tool component in the case of which the cutters are located on a large effective diameter. The modulus of elasticity and the tensile strength of the PBO fibers are particularly high, wherein the density is comparable to other fibers, as a result of which the PBO fibers cope with mechanical stresses and nonetheless ensure a good manageability. Even large-volume tool components can therefore significantly consist of fiber-plastics composite, as a result of which tools with a large nominal diameter and strongly reduced weight can be produced. This, in turn, creates the possibility to even clamp large tools on a relatively small clamping portion, in particular in the form of a hollow shaft cone (HSK) with a small diameter, due to the low weight. This has the advantage that spindles with smaller diameters can be used for receiving the tool, so that the spindle does not have to be adapted in a complex and cost-intensive manner, and existing or common spindles, respectively, can be used even for chip-removing rotary tools with a large construction volume to machine large inner diameters. In particular, a tilting moment of the tool, which is equipped with the tool component, is reduced by means of the weight minimization. The PBO fiber moreover has excellent resistance to chemicals. It has a low moisture absorption, has a high resistance against acids and alkalis, as well as a good compatibility with different fluids, which can appear during an operation of a chip-removing tool.

The thermosetting matrix system is ideally suited for an embedding of the PBO fibers. It has been shown that the bond between the matrix system and the PBO fiber is pronounced particularly strongly, as a result of which the PBO fibers can impart their coefficient of thermal expansion in a significant manner to the matrix system, so that the entire fiber-plastics composite ultimately has an adapted, very low coefficient of thermal expansion, and is nonetheless adapted to the requirements on occurring mechanical stresses. In conjunction with the matrix system, the high stiffness of the PBO fiber (approx. 270 GPa) allows the latter to dominate the thermal coefficient of thermal expansion. The thermal expansion of the fiber-plastics composite thus lies significantly below the value for, for example, carbon fiber-reinforced composites.

In other words, in addition to a negative coefficient of thermal expansion, the selected (PBO) fiber has to also have a high stiffness (in particular above 200 GPa), so that the properties (of the (PBO) fiber) can be transferred to the matrix system to a sufficient extent. A certain level of fiber/matrix bond has to be attained at the same time, and the (PBO) fiber requires a high tensile strength, so that it does not tear due to the resulting tensions. The PBO fiber meets all of these requirements. In response to a temperature increase, the PBO fiber contracts in the longitudinal direction or in the axial direction, respectively, due to the negative coefficient of thermal expansion, while the matrix system expands. Tensile loads thus result in the PBO fiber, pressure loads result in the matrix system. Due to the more than eighty-fold stiffness of the PBO fiber compared to the matrix system, the matrix system will adapt to the PBO fibers with its coefficient of thermal expansion.

The PBO fibers are currently offered only by the company Toyobo Co., LTD. with the names ZYLON® AS and ZYLON® HM.

The (high-modulus) PBO fiber with the name ZYLON® HM is particularly suitable for the selection as fiber component and is generally defined as the term PBO fiber in this application. In other words, the terms PBO fiber and ZYLON® HM are synonyms in the application.

The data sheet relating to the PBO fibers entitled “PBO FIBER ZYLON®” with the addition “Technical Information (Revised 2005.6)” in the form of a PDF file with 18 pages, was accessed at the end of 2018 under http://www.toyobo-global.com/seihin/kc/pbo/zylon-p/bussei-p/technical.pdf. The most important properties of PBO fibers are listed in point “1. Basic Properties”:

There are two types of PBO fibers, AS (as spun) and HM (high modulus).

| | ZYLON ® AS | ZYLON ® HM |
|---|---|---|
| Filament decitex | 1.7 | 1.7 |
| Density (g/cm∧3 | 1.54 | 1.56 |
| Tensile strength (cN/dtex) | 37 | 37 |
| (GPa) | 5.8 | 5.8 |
| (kg/mm ∧2) | 590 | 590 |
| Tensile modulus (cN/dtex) | 1150 | 1720 |
| (GPa) | 180 | 270 |
| (kg/mm ∧2) | 1800 | 28000 |
| Elongation at rupture (%) | 3.5 | 2.5 |
| Moisture absorption (%) | 2.0 | 0.6 |
| Decomposition temperature (° C.) | 650 | 650 |
| LOT | 68 | 68 |
| Coefficient of thermal expansion | — | −6 × 10 ∧(−6) |

Advantageous embodiments are claimed in the subclaims are described below.

Vinyl ester resin, epoxy resin, phenolic resin, and/or unsaturated polyester resin can preferably be selected as matrix component for the used thermosetting plastic matrix. The step of selecting the above matrix components in the method serves to further specify particularly suitable matrix components for the tool component. Compared to other matrix resins, unsaturated polyester resin is cost-efficient and has good resistance to chemicals, which are necessary in a use in a rotary tool. Due to the fact that a quick hardening is possible without any problems, the unsaturated polyester resin is also suitable for mass production. An influence of moisture in particular on the softening temperature is also negligible. Epoxy resins have an excellent adhesive and bonding property, and, due to the good fiber-matrix bond and the low vibration stresses, very good fatigue resistances are moreover attained. Vinyl ester resins are cost-efficient and likewise have a good fatigue resistance. They all have in common that they have a particularly good fiber-matrix bond with the PBO fibers, which is why at least one of the above-mentioned matrix components can be selected in the method.

Tests were able to show that it is particularly advantageous when the volume share of the PBO fibers in the fiber-plastics composite is selected to be equal to or larger than 40%. In addition to the components per se, the properties of the fiber-plastics composite also depend on the share thereof in the composite. For the manufacture of the tool components, the share represents an important, systematically adjustable parameter, wherein a volume share of the PBO fibers of above 40% is advantageous both from a production-related and product-related aspect. The volume share of the PBO fibers in the fiber-plastics composite can preferably be less than or equal to 70%, particularly preferably less than or equal to 60%. It is thus ensured that the PBO fibers are still held securely in the matrix system.

A further advantage of the invention is that the properties of the tool component can be controlled or configured, respectively, over wide ranges by the compilation and/or the orientation of the fibers.

In a preferred embodiment, the method can have the following steps: —providing the matrix system with the thermosetting plastic matrix as matrix component; —compiling PBO fibers as fiber component with selected length distribution, which is adapted to the field of use of the tool component; and—adding the PBO fibers to the matrix system in a selected quantity to the field of use, so that a semi-finished product comprising the unhardened matrix system and the PBO fibers is formed.

By means of the step of the compilation of the PBO fibers, a property of the fiber-plastics composite can be adjusted even more systematically in the method, and the fiber-plastics composite can be adapted to the field of use of the tool component. For example, depending on the field of use of the tool component, long PBO fibers and short PBO fibers can thus be combined, wherein the long fibers are embedded, for example, in a directed manner, and the short fibers are added in an unordered manner, in order to attain an even better strength and dimensional stability of the tool component. In addition, certain length regions of the length distribution of the PBO fibers can also be predetermined. In addition to the length distribution, the added quantity of the PBO fibers is also essential for the produced semi-finished product, which is to later be used as tool component. Thermosetting SMC (Sheet Molding Compound) or BMC (Bulk Molding Compound) molding compounds, which are adapted to hot pressing processing or also injection molding methods, respectively, are produced as semi-finished products by means of the embodiment of the method.

According to a further embodiment, the method can further have the steps of: pressing the semi-finished product into a heatable mold, and heating up and hardening the semi-finished product into a molded body of the tool component. These steps are used to completely molded and harden the semi-finished product in the form of an SMC or BMC molding compound, in order to finally be able to use the semi-finished product as tool component. It has been shown that it can be accomplished during the pressing of the semi-finished product to even further increase the wetting of the PBO fibers by means of the matrix, as a result of which the PBO fiber can be used even more effectively to increase the strength and to reduce the thermal expansion.

In the step of providing the matrix system, the unhardened matrix layer can preferably be applied to a carrier film, which is transported onward by means of a conveyor belt. To mass-produce the semi-finished products or the tool components, respectively, the method preferably has a conveyor belt, which moves the unhardened matrix layer to the next work station, at which the next method step is performed. To create a barrier between the conveyor belt and the matrix layer, which is generally sticky, the matrix layer is preferably applied to a thin carrier film, in particular a thin carrier film of polyethylene (PE). The carrier film does not have any significant impact on the fiber-plastics composite.

It is advantageous when in the step of adding the PBO fibers, the trimmed PBO fibers are applied, in particular dripped, onto the unhardened matrix layer of the matrix system. The PBO fibers can be applied to the unhardened matrix layer in a directed and/or undirected manner. This results in a layer of PBO fibers or a PBO fiber layer, respectively, which is located on matrix layer and which optionally penetrates into the latter, respectively. If the trimmed PBO fibers are dripped onto or dripped down onto to the matrix layer, respectively, a layer of PBO fibers results, which has a (two-dimensional) isotropic material property in the plane. The steps of applying the matrix system to the PBO fiber layer and of adding a further PBO fiber layer can preferably be repeated iteratively, for example in series.

It is further advantageous when after the step of adding PBO fibers, in particular with unordered dripping of PBO fibers onto the unhardened matrix layer applied to the carrier film, a further matrix layer is applied to the, in particular dripped on, PBO fibers, and a further carrier film is applied to the further matrix layer. A position configuration is created thereby, in the case of which the layer of the PBO fibers is surrounded centrally between the matrix layers. The outer sides of this position configuration are defined against the surrounding area by means of the carrier films, so that the unhardened matrix system does not adhere unintentionally. The carrier film has little volume and is selected in such a way that the fiber-plastics composite is not significantly influenced with respect to the properties.

The method can preferably further have the step that the semi-finished product is pressed and compacted by means of a compacting unit. To even better embed the PBO fibers into the matrix system and to remove air inclusions, of instance, the semi-finished product is compressed and flex-leveled by means of pressing power, for example running between two press rolls of the compacting unit.

In a preferred embodiment, the PBO fibers can be added in a mixture of fibers or a fiber mixture, respectively. The PBO fibers are present, preferably with a length of between 0.1 mm and 80 mm, particularly preferably between 1 mm and 60 mm, and most preferably between 10 mm and 50 mm. In particular long fibers are particularly well suited for a production of tool components, which have a large radial extension, so that from a production-related aspect as well as product-related aspect, centrifugal forces and tool reaction forces are absorbed reliably and largely deformation-free, and thermally induced position changes of the tool cutters remain limited.

The fiber mixture can in particular be compiled in such a way that in addition to a first length or a normal distribution of a first length of the PBO fibers, the fiber mixture additionally has a second length or a normal distribution of a second length of the PBO fibers. Depending on the specific application, different requirements of the tool component can be covered by means of the at least two lengths or normal distribution of two lengths, respectively.

It is further advantageous when in the step of compiling PBO fibers, at least one PBO fiber roving in the form of a flat strip is trimmed (/machined) by means of a cutting tool. The desired length distribution of the PBO fibers can thus be trimmed from a “continuous” PBO fiber roving, in particular from the roll, by means of the cutting tool. A bundle of PBO fibers arranged in parallel, more precisely of PBO fibers in the form of filaments (continuous fibers) are referred to as PBO fiber roving. A PBO fiber roving can thereby preferably have 1000 (1 k), 3000 (3 k), 6000 (6 k), 12000 (12 k), 24000 (24 k), or 50000 (50 k) of parallel PBO fibers. To ensure an even formation of the material properties, the number of the parallel PBO fibers in the PBO fiber roving preferably lies between 1000 (1 k) and 12000 (12 k).

Particularly preferably, the method can have the steps of:
forming a PBO fiber roving with circular or elliptical cross section (via discharge devices and deflection rollers) into the PBO fiber roving in the form of a flat strip; and
trimming the PBO fiber roving into PBO fiber roving cuttings with predetermined length distribution or length. Flat PBO fiber cuttings are particularly well suited to be embedded in the matrix system in layers. The flatter the PBO fiber cuttings are, the smaller a volume in the fiber-plastics composite, in which no PBO fiber cuttings can be introduced as a result of the geometry. One could also say that the PBO fiber cutting is in the form of a strip-shaped cutting. A PBO fiber cutting 12, which is as flat as possible, is essential for the quality of the fiber-plastics composite. It is crossed by crossing points and overlaps of individual PBO fiber cuttings. An approximately even and high volume content of the PBO fibers, which determines the (mechanical) properties, can be attained only by means of very flat PBO fiber cuttings.

With respect to the provision of a load-bearing tool component of a chip-removing tool in the design of a fiber-plastics-composite press-molded part, the object of the invention is solved according to the invention in that the load-bearing tool component has a matrix system comprising a thermosetting matrix component and PBO fibers embedded in the latter. As already described above with regard to the method, the specific fiber-plastics composite comprising a thermosetting matrix component and the PBO fibers is particularly suitable as material for a use as tool component in a tool. In a chip-removing tool, the tool component configured and provided in this way has a particularly high dimensional stability.

According to an embodiment, the PBO fibers embedded in the matrix system can be present in an unordered manner in such a way that an isotropic material property of the load-bearing tool component is attained at least in one plane. In response to a mechanical load in the radial direction, the tool component can thus absorb said load in a homogenous manner, and a direction of limited load capacity is avoided in the tool component.

In a further preferred embodiment, the tool component can be formed from pressed and hardened layers of semi-finished products comprising matrix system and PBO fibers. To provide a particularly stable tool component with corresponding thickness, several layers of semi-finished products, which in each case have the matrix system and the PBO fibers, are pressed and hardened. The individual layers of semi-finished products can in particular be designed differently. For example, a first layer can have directed PBO fibers with a first angle, and a second layer can have directed PBO fibers with a second angle. All layers can also be embodied or adjusted identically, respectively. It is likewise conceivable that a combination of layers comprising directed PBO fibers, and layers of PBO fibers located in a plane, is designed with two-dimensionally isotropic properties.

The PBO fibers, which are embedded in the matrix system of the load-bearing tool component, can preferably have a fiber length of between 0.1 mm and 80 mm, particularly preferably between 10 mm and 50 mm.

The coefficient of thermal expansion of the load-bearing tool component can in particular be less than or equal to 2 ppm/K, particularly preferably less than or equal to 1 ppm/K, in at least one direction, preferably a load-bearing plane, preferably in two directions, or in a load-bearing plane, particularly preferably in all three directions. This upper limit of the coefficient of thermal expansion ensures a dimensional stability of the tool even in the case of large thermal stresses.

According to an embodiment, the load-bearing tool component can be a carrier plate, a hollow shaft cone, a carrier plate, or a carrier portion of the chip-removing tool.

In a preferred embodiment, the load-bearing tool component can be a carrier plate, which has a plate-shaped basic structure as well as preferably at least one through opening transversely to the plate-shaped basic structure, in order to be screwed to other tool components and/or in order to be mounted thereon in a positive manner and/or in order to be connected by means of a substance-to-substance bond.

The load-bearing tool component can preferably have been produced according to the method according to the invention.

The matrix system can preferably be selected in such a way that the softening temperature/heat resistance temperature of the hardened matrix system is equal to or larger than 50° Celsius. The lower limit of the heat resistance temperature represents the minimum requirement of the tool component, in order to withstand the thermal stresses, in particular due to transferred frictional heat, which appear during a use.

In the step of adding the PBO fibers, the PBO fibers can preferably be added in such a way that the PBO fibers are present in the mixed compound in an unordered manner, in order to attain a three-dimensional isotropic material property of the tool component. Almost the entire tool, except for the cutters, can thus in particular also be formed, for instance, as tool component, without a certain orientation of the PBO fibers, which is to be observed, limiting the design of the tool component.

### BRIEF DESCRIPTION OF THE FIGURES

The invention will be described in more detail below on the basis of preferred embodiments with the help of figures, in which:

FIG. 1 shows a flow chart of a method according to the invention according to a preferred embodiment for producing a tool component according to the invention of a preferred embodiment,

FIG. 2 shows a perspective view of a device, which is adapted to a method according to the invention, according to a preferred embodiment, in the case of which a fiber-matrix semi-finished product is produced;

FIG. 3 shows a top view onto a fiber-plastics-composite layer produced according to the method;

FIG. 4 shows a scanning electron micrograph of a polished section of a fiber-plastics-composite layer produced according to the method with a first magnification, wherein the plane of the polished section lies parallel to the fiber,

FIG. 5 shows the scanning electron micrograph of FIG. 4 with a second magnification,

FIG. 6 shows a scanning electron micrograph of a polished section of a fiber-plastics-composite layer produced according to the method with a first magnification, wherein the plane of the polished section lies perpendicular to the fiber,

FIG. 7 shows the cross sectional view of the scanning electron micrograph from FIG. 6 in a second magnification,

FIGS. 8 and 9 show a longitudinal sectional view or a magnified detail view, respectively, of a fiber-matrix semi-finished product,

FIGS. 10 to 11 show a longitudinal sectional view or magnified detail view, respectively, of the finished, load-bearing tool component,

FIG. 12 shows a side view of the load-bearing tool component according to the invention,

FIG. 13 shows a schematic cross sectional view of a PBO fiber roving with elliptical cross section contour, which is formed into a PBO fiber roving with flat strip structure,

FIG. 14 shows a load-bearing tool component according to the invention according to a preferred embodiment, and

FIG. 15 shows the load-bearing tool component from FIG. 14, which is inserted into a rotary tool.

### DETAILED DESCRIPTION OF PREFERRED EMBODIMENTS

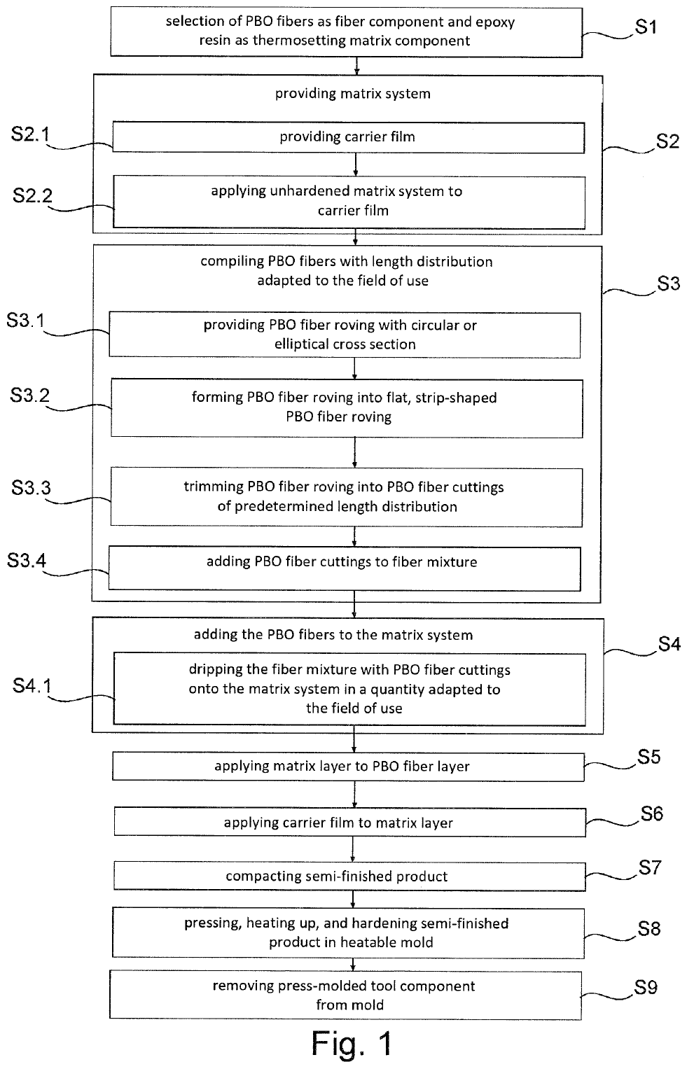

In a flowchart, FIG. 1 shows the individual steps of a method according to a preferred embodiment or an alternative, respectively, for producing a load-bearing tool component 1.

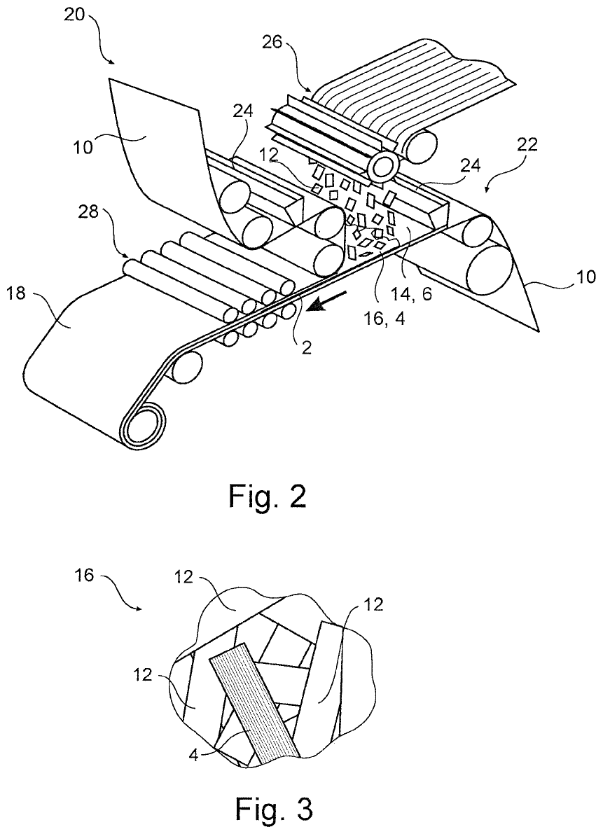

In a first step S1, as start of the method, PBO fibers 4 (ZYLON® HM) as fiber components as well as epoxy resin as thermosetting matrix component 8 of a matrix system 6 are selected for a fiber-plastics composite 2 (see FIG. 2). Thereafter, the method progresses into a step S2, in which the matrix system 6 is provided. The matrix system 6 thereby has epoxy resin as a (thermosetting) matrix component 8. The matrix system 6 can thereby have only epoxy resin as thermosetting matrix component 8, but also further matrix components, such as, for instance, vinyl ester resin or unsaturated polyester resins.

Step S2, providing the matrix system 6, comprises a step S2.1, providing a carrier film 10 (see FIG. 2) as well as a step S2.2, in which the unhardened matrix system 6 is applied to the carrier film 10.

The step S3, compiling PBO fibers with length distribution adapted to the field of use, takes place after the step S2. In this step S3, at least one PBO fiber roving 11 with circular or ellipsoidal/elliptical cross section is initially provided in a (first sub-)step S3.1. A (PBO fiber) roving is understood to be a bundle of parallel (PBO) fibers in the form of continuous fibers. The PBO fiber roving 11 is thereby unwound from a coil (not illustrated). So-called primary fibers and no recycled secondary fibers are used thereby. In a step S3.2, this PBO fiber roving 11 is thereafter formed into a strip-shaped PBO fiber roving 11′, which is as flat as possible, in order to attain the best possible fiber-matrix bond without disadvantageous hollow spaces, as described below. For example, the PBO fiber roving 11 can be guided via discharge devices and deflection rollers and can be fanned out as widely as possible. So as not to attain any continuous PBO fibers, the flat, strip-shaped PBO fiber roving 11′ is trimmed into PBO fiber cuttings 12 (see FIG. 3) of predetermined length distribution in a step S3.3. In this context, the term length distribution refers to the proportionate distribution of the present lengths of the PBO fibers, in the case of which the PBO fibers can be at hand of equal length (share of the single length in the length distribution is 100%, a single “peak”) or of a different length (trimmed) (at least two different lengths with respective shares of below 100%). One could also say that the length distribution is a function over the length, the value of which reflects the share of the length, wherein the sum of the share is 100%. In the event that the PBO fibers have different lengths, the length distribution can have, for example, exactly two or more defined, different lengths of PBO fibers. The length distribution can also be a normal distribution of the length of the PBO fibers by a maximum of a certain length. Together with optionally further fibers, these PBO fiber cuttings 12 form a fiber mixture. In addition to the PBO fiber cuttings 12, the fiber mixture can have further fibers, such as, for instance, carbon fibers. The fiber mixture can in particular have only the plurality of PBO fiber cuttings 12 of a single predetermined length.

In a step S4, the fiber mixture with the PBO fiber cuttings 12 is then lastly added to the matrix system 6. This takes place in a defined manner by means of a step S4.1, dripping of the fiber mixture with the PBO fiber cuttings 12 in a quantity, which is adapted to the field of use, onto a matrix layer 14 of the matrix system 6. A fiber layer 16 with (at least) the PBO fiber cuttings 12, which bears on the matrix layer 14 of the matrix system 6 and which optionally protrudes into said matrix layer and penetrates into the latter, is thus created. A volume share of the PBO fibers 4 in the fiber-plastics composite 2 can also be adjusted via the quantity, which is adapted to the field of use.

To embed the PBO fibers 4 or the PBO fiber cuttings 12, respectively, into the matrix system 6 primarily completely, the application of a further matrix layer 14 of the matrix system 6 onto the fiber layer 16 takes place in a step S5. To produce a semi-finished product 18, which can also be handled well and which does not adhere in particular to system components during further processing, a further carrier film 10 is applied to the applied further matrix layer 14 in a step S6. A sandwich configuration thus results as the semi-finished product 18 consisting of carrier film 10, matrix layer 14, fiber layer 16, matrix layer 14, and carrier layer 10, in the case of which the fiber layer 16 is placed symmetrically between the other layers and is in particular embedded. The matrix layers 14 form the thermosetting plastic matrix 8.

In a subsequent step S7, the semi-finished product 18 produced in this way is compacted and in particular flex-levelled by means of a compacting unit. In this state, the produced semi-finished product 18 can be handled, in particular stored, transported, shaped, in particular trimmed, torn, or bent. Several layers of the semi-finished product 18 can also be placed one on top of the other or stacked one on top of the other in layers, wherein the carrier films 10 between the layers are in each case removed.

After the carrier films 10 have been removed, the compacted semi-finished product 18 is subsequently fed to a heatable (heating press) mold, in particular placed into said mold, which presses the semi-finished product 18 in a positive manner and thus brings it into its final shape, heats up and hardens by means of the press heating process, in order to lastly demold the tool component 1 according to the invention in the design of a fiber-plastics-composite press-molded part. The viscosity of the matrix system 6 thereby initially decreases strongly under the high pressure and the high temperature, and allows for a (partial) flowing of the matrix system 6. In this state, the PBO fibers 4 are wetted completely by the matrix system 6, or the PBO fibers 4 have a direct contact with the matrix system 6, respectively, if possible on all surfaces. Shortly afterwards, the matrix system 6 reacts with associated increase of its viscosity and hardens.

In a last step S9, the press-molded tool component 1 is lastly removed from the heatable mold and can be used in a chip-removing tool.

In a perspective view, FIG. 2 shows a (manufacturing) method according to the invention or an SMC system 20 (Sheet-Molding-Compound System 20), respectively, which is adapted to a method according to the invention, for producing the semi-finished product 18 for the fiber-plastics-composite tool component 1 according to the invention according to a further, second preferred embodiment. This second embodiment/alternative of the method is a subset of the first embodiment, wherein the steps S8 and S9 are not used, because only the semi-finished product 18 is produced for a later processing.

Concretely, FIG. 2 shows the SMC system 20, in the case of which a carrier film 10 in the form of a PE cover film is unwound and is fed to the further method stations (see arrow for direction of movement) on a conveyor belt 22 (step S2.1). The matrix system 6 or the matrix layer 14, respectively, is applied or squeegeed, respectively, to the carrier film 10, which is transported onward by means of the conveyor belt 22, by means of a squeegee unit 24, to the carrier film 10 (step S2.2). The matrix system 6 is (at least partially) provided thereby (step S2).

Above the squeegee unit 24, the flat, strip-shaped PBO fiber rovings 11′ run parallel and in the same direction as the conveyor belt 22, running side by side. These strip-shaped, parallel PBO fiber rovings 11′ are fed to a cutting device 26, which cuts them into the desired length. After the cutting, the PBO fiber roving 11′ disintegrates loosely into individual fibers, adhere to one another electrostatically and which form the flat PBO fiber cuttings 12. Even though a partial falling apart of the PBO fibers 4 in the PBO fiber cuttings 12 is possible, it hardly takes place. In this embodiment, these PBO fiber cuttings 12 form the fiber mixture. The cut PBO fiber cuttings 12 fall in an unoriented manner onto the epoxy resin film, which forms the matrix layer 14 of the matrix system 6, and are thus dripped on (step S4.1). A fiber content or a volume share, respectively, of the PBO fibers 4 in the fiber-plastics composite 2 can be adjusted via the web speed of the conveyor belt 22.

The fiber layer 16 applied in this way on the matrix layer 14 and the carrier film 10 is transported onward by means of the conveyor belt 22, and a further carrier film 10, to the underside of which a further matrix layer 14 of the matrix system 6 is applied with the help of a further squeegee unit 24, covers the fiber layer 16 (steps S5 and S6). A semi-finished product 18 is now present as web, in the case of which the fiber layer 16 is surrounded by the matrix layers 14.

This semi-finished product 18 is guided through downstream a rolling mill 28, where the matrix system 6 or the two matrix layers 14, respectively, with the PBO fibers 4 or the fiber layer 16, respectively, are flex-levelled into one another, in order to connect the two layers 14, 16 to one another well, in order to embed the PBO fibers 4 into the matrix system 6 as well as possible, and in order to reduce possible hollow spaces of air inclusions or of fiber shares, which are too small, and to avoid them completely, if possible. The semi-finished product 18 in web-shape is wound onto rolls at defined weights and is stored for several days until reaching the thickening depth. This semi-finished product 18 as SMC molding compound (Sheet Molding Compound) can then in particular be trimmed, so that an SMC molding compound, which is adapted to the heatable mold, is molded.

In a partial view, FIG. 3 shows a schematic top view onto the fiber layer 16, in which the PBO fiber cuttings 12 are located one on top of the other in an unordered manner and form layers. Ideally, a PBO fiber cutting 12 has a thickness of exactly one fiber of the PBO fiber 4, or the thickness corresponds to the diameter of an individual PBO fiber 4 of approx. 10 μm, respectively. An approximately even and high fiber share or volume share, respectively, of the PBO fibers 4 is thus attained.

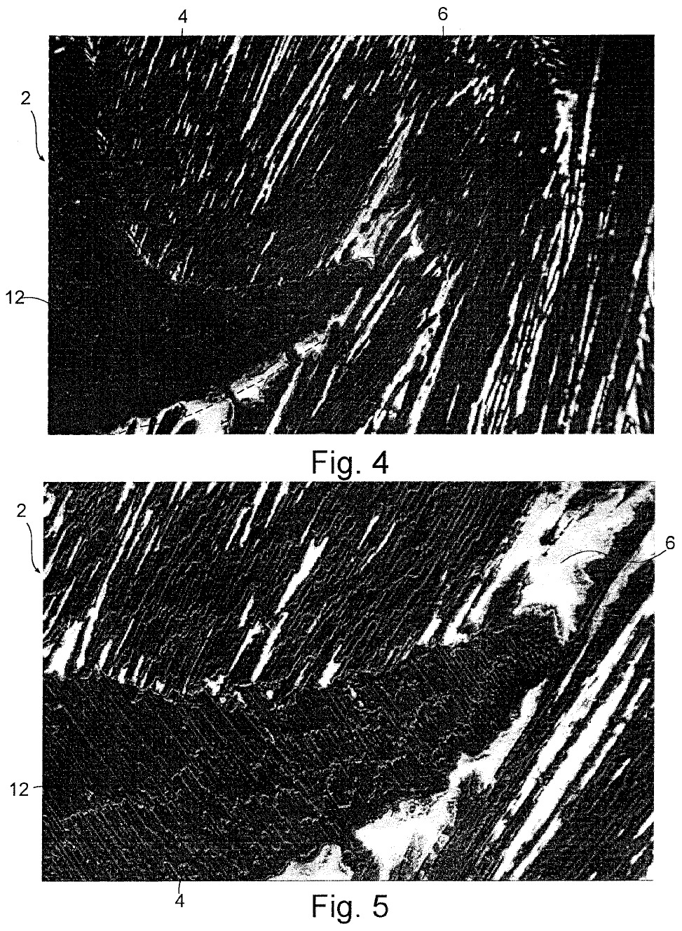

FIGS. 4 and 5 in each case show a scanning electron microscope (SEM) image with two different magnification levels. The two FIGS. 4 and 5 show a polished section of a fiber-plastics-composite layer 2 produced according to the method, wherein the plane of the polished section lies parallel to the PBO fibers 4. This plane is also drawn in schematically in FIG. 11 with the description “sectional plane parallel to the PBO fiber”. The SEM image thus corresponds to a top view onto the individual layers of the fiber-plastics composite 2, as it is suggested, for instance, in FIG. 3. An individual PBO fiber cutting 12, seen in FIG. 4 on the left-hand side, is surrounded roughly with a dashed line. It can be seen clearly in FIGS. 4 and 5 that the individual, flat PBO fiber cuttings 12 only have few PBO fibers 4 one on top of the other in a direction perpendicular into the side plane, or a thickness of only a few PBO fibers 4, respectively. A PBO fiber cutting 12 has in particular fewer than ten layers of PBO fibers 4 in the direction of its smallest extension. In FIG. 5, which is the fivefold magnification of the fiber-plastics composite 2 from FIG. 4, a line parallel to the PBO fibers 4 is drawn in in the center. Along this line, viewed starting from the top right, leading to the bottom left in FIG. 5, a first layer of PBO fibers 4 can be seen, which is provided with the designation (1). A second, third, fourth, and fifth layer are in each case identified with (2), (3), (4), and (5). This PBO cutting 12 thus only has five layers of PBO fibers 4, viewed into the side plane. The frayed ends of the PBO fibers 4 originate from the polished section for the SEM image, in the case of which the surface was polished off to be flat. Bright regions represent the matrix system 6, whereas the dark, fiber-shaped regions represent the PBO fibers 4.

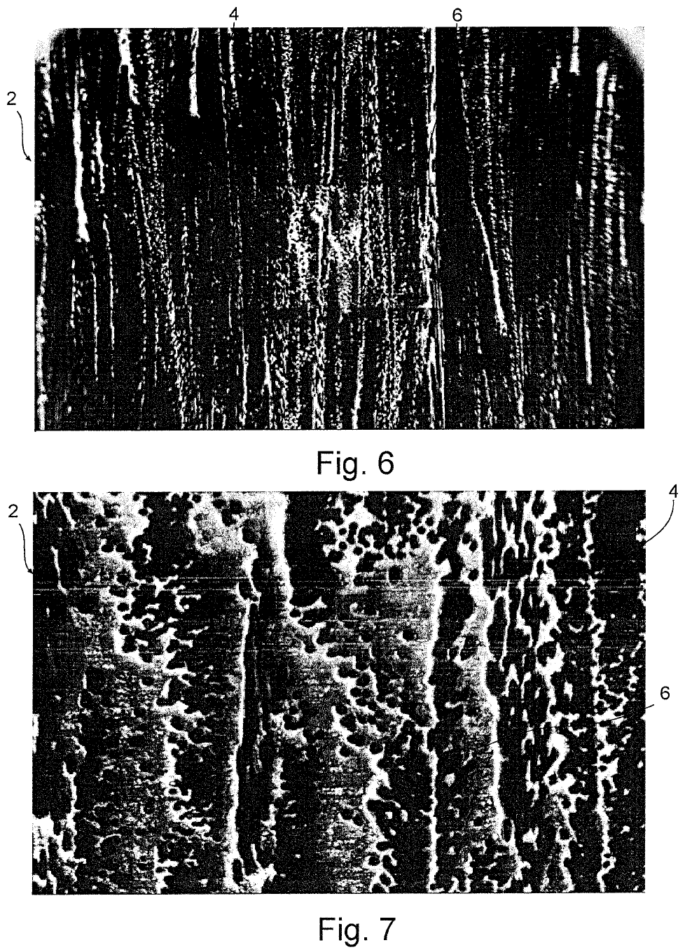

FIGS. 6 and 7 likewise show a scanning electron microscope image of a polished section of a fiber-plastics-composite layer 2 produced according to the method in two different magnifications, wherein, this time, the plane of the polished section lies perpendicular to the PBO fibers 4. In other words, FIGS. 6 and 7 in each case show a cross sectional view of the hardened fiber-plastics composite 2, wherein the (sectional) plane is shown schematically in FIG. 11 with the description “sectional plane perpendicular to the PBO fiber”. For example, elliptical cross sections of the PBO fibers 4 show that these cut-off PBO fibers 4 have a different orientation in the plane, in which the PBO fibers 4 of a layer are located, than, for example, the PBO fibers 4 with circular cross section. It can also be seen that the volume share of the PBO fibers 4 is higher than the volume share of the matrix system 6.

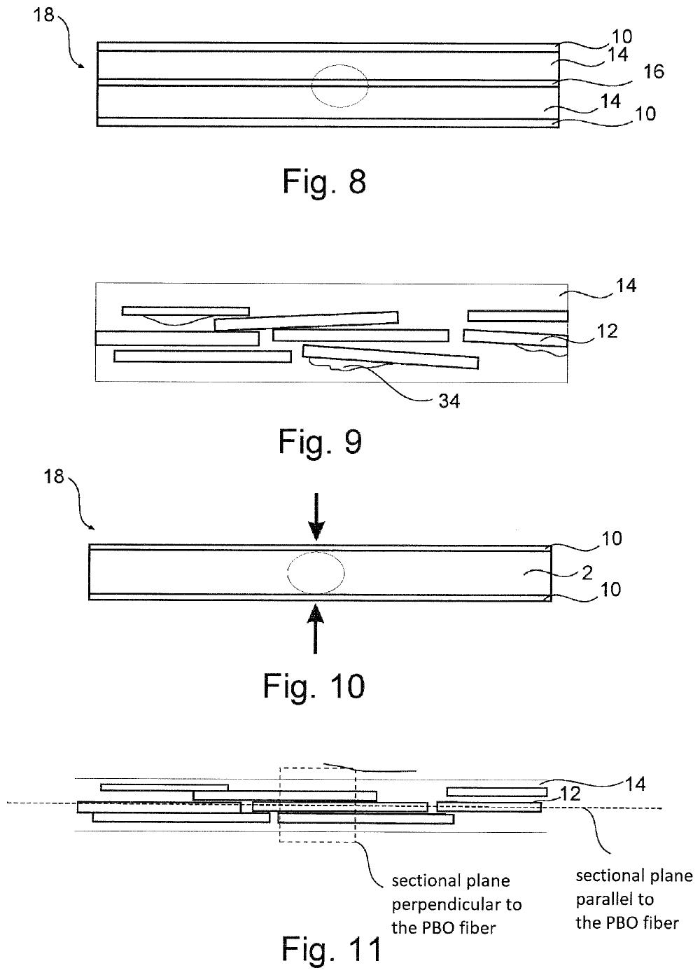

FIG. 8 shows a schematic longitudinal sectional view through the semi-finished product 18, which was produced by means of the above-described SMC system 20. A layered composite of the carrier film 10, the matrix layer 14, the fiber layer 16, the matrix layer 14, and the carrier film 10, can be seen, which is present after the step S6, applying the carrier film 10. The layers 10, 14, 16 of the layered composite bear loosely one on top of the other and have not been compacted yet.

In a schematic detail view, FIG. 9 shows a magnified partial section, which is suggested with the ellipsis in FIG. 8, essentially through the fiber layer 16 of the layered composite of the semi-finished product 18 from FIG. 8. The introduced PBO fiber cuttings 12 are not yet completely embedded in the matrix layers 14 at some points, but air inclusions 34 are still present, which have a negative impact on a bonding of the matrix system 6 with the PBO fibers 4 or the PBO fiber cuttings 12, respectively. Surfaces of the PBO fiber cuttings 12 are thus present, which are not in direct contact with the matrix layers 14. To attain an embedding, which is as complete as possible, of the PBO fiber cuttings 12, the step S7, compacting of the semi-finished product 18 follows, in which the semi-finished product 18 is compacted and the PBO fibers 4 are flex-levelled into the matrix system 6.

FIG. 10 shows a longitudinal sectional view through the semi-finished product 18 after the step S7, compacting, during which the semi-finished product 18 comprising the fiber-plastics composite 2 was flex-leveled by means of the rolling mill/the compacting unit 28. The two oppositely directed arrows thereby suggest the applied pressing force of the press rolls.

In a schematic detail view, FIG. 11 shows, identical to FIG. 9, the magnified partial section, which is suggested in FIG. 10 with an ellipsis, through the fiber layer 16 of the layered composite of the semi-finished product 18 from FIG. 10, after the steps S7, compacting, and S8, pressing, heating, and hardening of the semi-finished product 18 in the heatable mold (not illustrated). The thickness (dimensions in FIGS. 8 to 11, viewed in the vertical direction) of the semi-finished product 18 was reduced on the one hand, the air inclusions 34 were removed on the other hand.

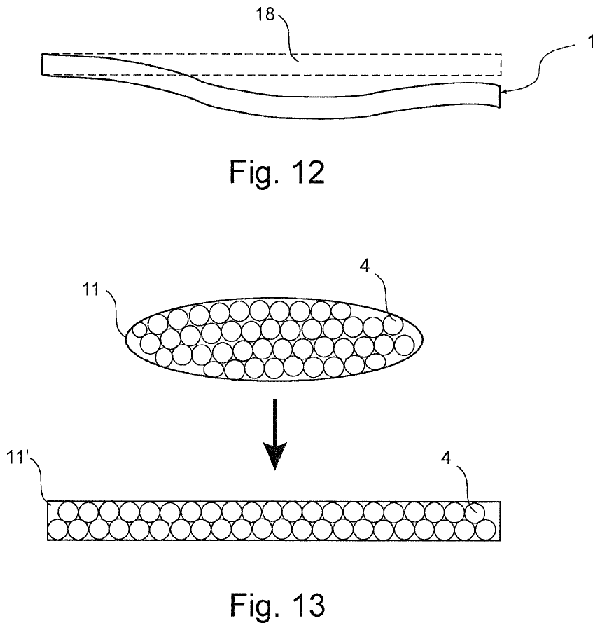

Schematically, FIG. 12 shows a side view of the semi-finished product 18, which was press-molded into the final fiber-plastics-composite tool component 1 after the step S8, pressing, heating, and hardening of the semi-finished product 18 in a heatable mold (not illustrated).

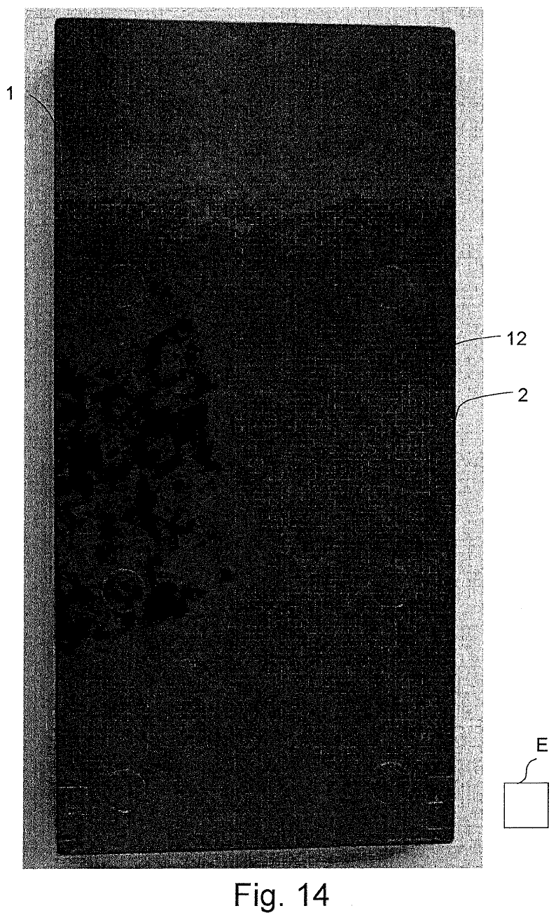

In a cross sectional view through the PBO fiber roving 11, FIG. 13 shows in a schematic manner the step S3.2 forming the PBO fiber roving 11 with elliptical cross section into a flat, strip-shaped PBO fiber roving 11′ with the smallest possible thickness (the thickness with approximately two fiber diameters is illustrated schematically in FIG. 13). The thickness of the strip-shaped PBO fiber roving 11′ is thereby defined as the distance of the side surfaces, viewed in the vertical direction, in FIG. 13. When cut off, the PBO fiber cuttings 12 then likewise result with the smallest possible thickness.

FIG. 14 shows a top view onto a tool component 1 according to the invention of a preferred embodiment in the form of a carrier plate with plate-shaped basic structure 36. The PBO fiber cuttings 12, which are located one on top of the other and which are embedded in the matrix system 6, can be seen, which are located in a plane (in FIG. 14 identified with plane E here) in an undirected manner and which thus effect a two-dimensional isotropic material property of the tool component 1. The tool component 1 is formed from several layers of the pressed and hardened semi-finished product 18, in order to attain a necessary thickness (seen in FIG. 14 the dimension perpendicular into the side plane/figure sheet plane or perpendicular to the plane E, respectively) and stiffness of the carrier plate, and in order to absorb the mechanical stresses.

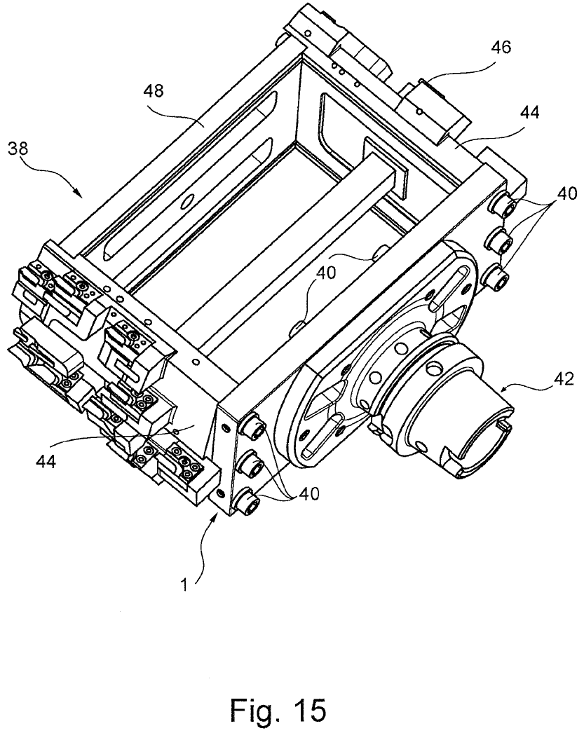

FIG. 15 shows the tool component 1, which was produced from the carrier plate shown in FIG. 14, wherein the tool component 1 in the form of the carrier plate is inserted into a chip-removing rotary tool 38 comprising a modulus-like base body or modulus-like carrier, respectively. The tool component 1 is thereby fastened to a clamping portion 42 as well as to carrier portions 44 by means of screws 40 in the axial direction. The carrier portions 44, which carry cutters 46, the clamping portion 42, here in the form of a hollow shaft cone receptacle, and/or a carrier plate 48 fastened on the front side, can have the fiber-plastics composite 2 with the PBO fibers 4 as material, or can consist completely of the fiber-plastics composite 2. The entire rotary tool 38, optionally except for smaller elements, such as, for instance, the screw 40, the cutter 46, or cutter inserts, can be constructed from the fiber-plastics composite 2. Due to the fact that the weight of the rotary tool 38 with a large diameter is low, a clamping portion 42 with a small diameter can be used. This allows for the use on a spindle with a small diameter, as it is currently used in the case of machine tools.

Any disclosure in connection with the method according to the invention for producing a fiber-plastics-composite tool component also applies for the load-bearing tool component according to the invention, and any disclosure in connection with the load-bearing tool component according to the invention also applies for the method according to the invention.

It goes without saying that deviations from the above-described embodiments are possible, without leaving the basic idea of the invention. For example, the production method of the fiber-plastics composite can differ from the described alternative to the effect that the fiber-plastics composite is produced in 3D printing (additive manufacturing), wherein the fibers are embedded in the matrix to be printed, for example as continuous fibers or continuous fiber rovings, respectively. The fibers are thereby placed in such a way by means of a positioning device that they are implemented in the component or the tool component, respectively, during the matrix discharge or plastic discharge, respectively, directly by means of the discharged plastic. For example, fiber-plastics-composite tool components can thus be manufactured additively from granulate with continuous fibers. The tool components can thus be applied layer by layer of the finest plastic drops with the help of a special nozzle onto a movable component carrier, and can thus be constructed to form 3D components.

### LIST OF REFERENCE NUMERALS

1 fiber-plastics-composite tool component
2 fiber-plastics composite
4 PBO fiber
6 matrix system
8 thermosetting matrix component
10 carrier film
11 PBO fiber roving (circular or elliptical cross section)
11′ PBO fiber roving (flat, strip-shaped)
12 PBO fiber cutting
14 matrix layer
16 fiber layer
18 semi-finished product/preform
20 SMC system
22 conveyor belt
24 squeegee unit
26 cutting device
28 rolling mill/compacting unit
34 air inclusion
36 plate-shaped basic structure
38 rotary tool
40 screw
42 clamping portion
44 carrier portion
46 cutter
48 carrier plate
S1 step selecting PBO fibers and thermosetting matrix
component
S2 step providing matrix system
S2.1 step providing carrier film
S2.2 step applying matrix system to carrier film
S3 step compiling PBO fibers
S3.1 step providing PBO fiber roving
S3.2 step forming PBO fiber roving
S3.3 step trimming PBO fiber roving
S4 step adding PBO fibers to matrix system
S4.1 step dripping the fiber mixture with PBO fiber cuttings
S5 step applying matrix layer to PBO fibers
S6 step applying carrier film
S7 step compacting semi-finished product
S8 step pressing, heating, and hardening semi-finished product
S9 step removing tool component

1. A method for producing a fiber-plastics-composite tool component comprising providing a matrix system comprising embedded fiber and a thermosetting plastic matrix, the fiber comprising PBO fibers, the thermosetting plastic matrix having such a bond to the PBO fiber in the hardened fiber-plastics composite that a coefficient of thermal expansion of the PBO fibers is imparted to the matrix system.

2. The method according to claim 1, wherein vinyl ester resin, epoxy resin, phenolic resin, and/or unsaturated polyester resin is selected as matrix component for the used thermosetting plastic matrix.

3. The method according to claim 1, wherein a volume share of the PBO fibers in the fiber-plastics composite is equal to or larger than 40%.

4. The method according to claim 1, wherein the method further comprises:
providing the matrix system with the thermosetting plastic matrix as matrix component,
compiling PBO fibers as fiber component with selected length distribution, which is adapted to the field of use of the tool component, and
adding the PBO fibers to the matrix system in a selected quantity to the field of use, so that a semi-finished product comprising the unhardened matrix system and the PBO fibers is formed.

5. The method according to claim 4, wherein the method further comprises:
pressing the semi-finished product into a heatable mold, and
heating up and hardening the semi-finished product into a molded body of the tool component.

6. The method according to claim 4, wherein in said providing the matrix system, the unhardened matrix layer is applied to a carrier film, which is transported onward by a conveyor belt.

7. The method according to claim 4, wherein in said adding the PBO fibers, the trimmed PBO fibers are applied, onto the unhardened matrix layer of the matrix system.

8. The method according to claim 7, wherein said adding PBO fibers comprises adding PBO fibers with unordered dripping of PBO fibers onto the unhardened matrix layer applied to the carrier film, and said method further comprises applying a further matrix layer to the dripped-on PBO fibers after said adding PBO fibers with unordered dripping, and applying a further carrier film to the further matrix layer.

9. The method according to claim, wherein the method further comprises pressing and compacting the semi-finished product by a compacting unit.

10. The method according to claim 4, wherein the PBO fibers are included in a fiber mixture, wherein the PBO fibers have a length of between 1 mm and 80 mm.

11. The method according to claim 10, wherein the fiber mixture is compiled in such a way that in addition to a first length or a normal distribution of a first length of the PBO fibers, the fiber mixture additionally has a second length or a normal distribution of a second length of the PBO fibers.

12. The method according to claim 4, wherein in said compiling PBO fibers, at least one PBO fiber roving in the form of a flat strip is trimmed by a cutting tool.

13. The method according to claim 12, wherein the method comprises:
forming a PBO fiber roving with circular or elliptical cross section into the PBO fiber roving in the form of a flat strip, and
trimming the PBO fiber roving into PBO fiber roving cuttings with predetermined length distribution or length.

14. A load-bearing tool component of a chip-removing tool in the design of a fiber-plastics-composite press-molded part, wherein the load-bearing tool component has a matrix system comprising a thermosetting matrix component and PBO fibers embedded in the thermosetting matrix component.

15. The load-bearing tool component according to claim 14, wherein the tool component is formed from pressed and hardened layers of semi-finished products with matrix system and PBO fibers.

16. The load-bearing tool component according to claim 14, wherein the PBO fibers embedded in the matrix system are present in an unordered manner in such a way that an isotropic material property of the load-bearing tool component is attained at least in one plane.

17. The load-bearing tool component according to claim 14, wherein the PBO fibers, which are embedded in the matrix system, have a fiber length of between 1 mm and 80 mm.

18. The load-bearing tool component according to claim 14, wherein a coefficient of thermal expansion of the load-bearing tool component is less than or equal to 2 ppm/K.

19. The load-bearing tool component according to claim 14, wherein the load-bearing tool component is a carrier plate, a hollow shaft cone, a support plate, or a carrier portion.

20. The load-bearing tool component according to claim 19, wherein the load-bearing tool component is a carrier plate, which has a plate-shaped basic structure, in order to be screwed to other tool components and/or in order to be mounted thereon in a positive manner and/or in order to be connected by means of a substance-to-substance bond.

21. The load-bearing tool component according to claim 14, wherein the load-bearing tool component was produced according to a method comprising providing a matrix system comprising embedded fiber and a thermosetting plastic matrix, the fiber comprising PBO fibers, the thermosetting plastic matrix having such a bond to the PBO fiber in the hardened fiber-plastics composite that a coefficient of thermal expansion of the PBO fibers is imparted to the matrix system.

22. The method according to claim 4, wherein in said adding the PBO fibers, trimmed PBO fibers are dripped onto the unhardened matrix layer of the matrix system.

23. The method according to claim 4, wherein the PBO fibers are included in a fiber mixture, wherein the PBO fibers have a length of between 10 mm and 50 mm.

24. The load-bearing tool component according to claim 14, wherein the PBO fibers, which are embedded in the matrix system, have a fiber length of between 10 mm and 50 mm.

25. The load-bearing tool component according to claim 14, wherein a coefficient of thermal expansion of the load-bearing tool component is less than or equal to 1 ppm/Kin all three directions.

26. The load-bearing tool component according to claim 19, wherein the load-bearing tool component is a carrier plate, which has a plate-shaped basic structure as well as at least one through opening transversely to the plate-shaped basic structure, in order to be screwed to other tool components and/or in order to be mounted thereon in a positive manner and/or in order to be connected by a substance-to-substance bond.
